(19) United States
(12) Patent Application Publication
(10) Pub. No.: US 2011/0182053 A1
(43) Pub. Date: Jul. 28, 2011

(54) Omni-directional and multi-directional light-emitting diode (LED) lamp designs with multiple discrete LEDs on multiple facets

(76) Inventor: Mujibun Nisa Khan, Colts Neck, NJ (US)

(21) Appl. No.: 12/657,761

(22) Filed: Jan. 27, 2010

(51) Int. Cl. F21V 9/16; F21S 4/00; F21V 9/00

(52) U.S. Cl. 362/84; 362/249.02; 362/231

(57) ABSTRACT

An LED lamp design concept with LEDs on multiple facets of a solid to produce substantially omni-directional light or multi-directional light is disclosed. Currently, conventional LEDs produce beams confined in a narrow region because they are single-sided planar sources, unlike point-sources. An LED chip is planar because it is very thin and rectangular and has a height that is substantially smaller than its width and length—similar to a thin sheet of paper where light only comes from one side while the other is blocked. Today's common LEDs emit light from a tiny, thin rectangular region placed on a much larger substrate and light is emitted from top surface only, confining light to a narrow region, unlike a point-source producing omni-directional light. Currently, LED lamps are produced by placing multiple chips on a plane, producing substantially directional light. An omni-directional lamp is better for general illumination than a narrow-directional one.

### BACKGROUND OF THE INVENTION

### Field of the Invention

Solid state lighting (SSL), which uses light emitting diodes (LED) as the light source, has been an important field for the last several years particularly due to the wake of increased global energy demand and limited resources. Advances in SSL has been remarkable in terms of how fast their efficiency, light output and quality have improved in the past few years. Today many diverse applications in illumination and display industries are gaining acceptance because of the notable improvement and because LEDs promise to offer significant energy savings over current light sources; further, their flexible form factors, scaling, and attractive color combination capabilities have attracted many architectural and decorative lighting designers for residential and commercial buildings—both indoors and outdoors.

Although SSL capabilities are unique and promising, the industry still faces numerous challenges that keep lingering and thereby adversely affecting the large growth industry experts have been anticipating. One such challenge is the highly directional light output from a typical LED source [1], which is undesirable for many general illumination applications that require broad spatial lighting.

Currently general illumination is largely accomplished using incandescent and fluorescent lamps such as those in our homes and offices; the streets and parking lots predominantly use mercury halides and high-pressure sodium lights at night; all of these light sources provide much more omni-directional (or multi-directional) light than LED light sources do at the present time. Incandescent light sources provide light in different directions which is quite omni-directional because the glowing filament covers a fairly broad area and is effectively suspended in space without much blockage around it. This allows the filament to emit light in many directions covering space that is above, below, and around it. A compact fluorescent light has fairly large 3-dimensional (3-D) emitting region that is made up of twisted tubes. A linear fluorescent light also has a large 3-dimensional (cylindrical to be more specific) emitting region and light can come radially out in 360 degrees all along the length of the cylinder.

The 3-dimensional construction with fairly comparable width, height, and depth sizes along with fairly large emitting regions (on the order of inches or feet) of incandescent, compact fluorescent and various other gas discharge lamps allow for light emission in many directions. In contrast, typical LEDs are substantially planar or 2-dimensional and light is only allowed to escape from only one side of the LED chip that is typically about a 1 mm×1 mm (width×length). Such construction and small dimensions restrict light coming from LED sources to a fairly small conical region and therefore is not considered very effective for general illumination of home, office, and other spatial lighting applications.

Due to the directional nature of LED lamps, solid-state lighting has so far been primarily restricted to such niche applications as decorative, task, flash lighting [2]. However, SSL is greatly touted as the next-generation light source where general illumination is expected to be the Holy Grail [3]. To live up to the expectation, LED lamps must generate omni-directional or substantially omni-directional, or targeted multi-directional light, which this invention offers to solve.

This invention relates to an LED lamp and luminaire design that is thought and expected to produce light in multiple directions simultaneously while the LED lamp stays stationary; it can also closely mimic omni-directional light. In other words, the designs disclosed here will generate multi-directional and substantially omni-directional light from a fixed LED lamp or luminaire and will help provide desirable illumination for general purpose lighting.

More specifically this invention relates to a lamp configuration that includes multiple discrete LEDs on multiple surfaces of a solid or of a 3-D object that comprise the LED source. For example, the LED lamp source can be made to look like a cube or a rectangular solid where all six facets of the solid can be populated with discrete LEDs. In general, an LED lamp can be designed to have any 3-dimensional shape and all or some of its surfaces can be populated with discrete LEDs. These 3-dimensional LED lamps can produce light in many directions, and particularly in the directions light is needed to illuminate a designated 3-dimensional space such as a home room, attic, an office, streets and parking lots. While a truly omni-directional light may be difficult to produce with discrete LEDs, the closest omni-directional LED lamp can be constructed using a geodesic sphere with discrete LEDs covering as many of its surfaces as possible. A simpler version could be an octahedron or a dodecahedron solid with all of its 8 or 12 surfaces covered with discrete LEDs. Here the discrete LEDs can be in the chip or module forms or both.

This design concept can also be applied to organic LED (OLED) lamps where OLEDs may be used as discrete LEDs which usually have larger chip sizes than conventional LEDs; multiple OLEDs may be used on multiple surfaces of a solid or of a 3-D object to generate multi-directional or omni-directional light. The advantage of OLEDs may be that they can be large area devices and a sphere could be constructed where the entire surface of the sphere can be evenly covered with OLEDs, in principle. Theoretically this would produce omni-directional light! Similarly the planar surfaces of any polyhedron such as an octahedron or a dodecahedron can be covered with broad area OLEDs to produce substantially omni-directional light.

Currently most LED light source designs produce highly directional light output in contrast to the more omni or broad-directional light that other lamps produce. Today's typical LED sources produce substantially directional light because LED chips are thin and rectangular and light only emanates from one side of the chip as the other side is blocked by the large substrate on which it is placed as shown in FIGS. 1 and 2. Configurations in FIGS. 1 and 2 are typical of what the SSL industry currently employs.

Currently most high-brightness LED chips are 1 mm×1 mm (width×length), which are the dimensions on the wafer surface; I refer to them as lateral dimensions in this document. The vertical height or thickness of the LED chip is much less than a millimeter and the active region of the semiconductor diode is on the order of a micron, which is one-thousandth of a millimeter. Consequently, the LED chip or die is essentially like a thin sheet of paper and light only comes out of one side of the thin die. These chip dimensions have become common in the industry currently because of manufacturing challenges limit the chip size as inorganic semiconductor material morphology is dictated by unavoidable defect densities. In order to generate more light or lumens from a single LED light source or luminaire, most current manufacturers use multiple chips on the same board or substrate as shown in FIG. 3.

The LED light sources are typically constructed by using chip and board designs in FIGS. 1, 2, and 3, which suffer from highly directional light that is not desirable or effective for general illumination. Such light sources may be acceptable for task lighting, small area lighting and flash lighting. In order to illuminate objects and spaces far from the light source, light sources need to bright and emanate light in multiple directions—often all around the light source or at least mostly around the light source.

The designs proposed in this invention is shown in FIGS. 4 a, b, and c and in FIGS. 5 and 6. The basic concept of these multi-directional LED lamp/luminaires is that discrete LEDs are placed on multiple surfaces of the lamp to produce light in many directions. The discrete LEDs may be integrated on each surface at the chip or die level or they can be put together in an array using packaged LED modules. In case of an OLED lamp, the OLEDs may be discrete or each surface of a polyhedron may be entirely covered with a broad-area OLED.

LEDs need to remove a good amount of heat from the lamp/luminaire unit because excessive heat reduces the LED wall-plug efficiency and reduces the lamp lifetime substantially. Effective thermal management of LED lamps and luminaires is a serious subject of study and implementation in the SSL industry today. In order to allow for heat removal in the proposed LED lamp/luminaire, heat sinks may be used at the back of the surfaces of the solid lamp as shown in FIG. 4c.

### SUMMARY OF THE INVENTION

Current LED light sources produce highly directional light and therefore pose a challenge for being seriously considered for general illumination. Although ‘general illumination’ is a broad term that applies to various applications and products, currently it is meant for general purpose home, office, and other indoor and outdoor lighting that we commonly use. Incandescent and various fluorescent and other gas discharge lamps are used for these applications which all produce fairly multi-directional light to illuminate our desired space in contrast to highly-directional light current LED lamps produce.

This invention offers some LED lamp and luminaire designs that are thought and expected to produce light in multiple directions and well as produce light in a fashion that closely mimics omni-directional light. In other words, the designs disclosed here are expected to generate multi-directional and substantially omni-directional light from an LED lamp or luminaire that will help provide effective illumination for general purpose as well as other lighting.

Specifically this invention relates to a lamp configuration that includes multiple discrete LEDs on multiple surfaces of a solid or of a 3-D object that comprise the LED source. For example, the LED lamp source can be made to look like a cube or a rectangular solid where all six facets of the solid can be populated with discrete LEDs. In general, an LED lamp can be designed to have any 3-D shape and all or some of its surfaces can be populated with discrete LEDs. These 3-D LED lamps can produce light in many directions, and particularly in the directions light is needed to illuminate a designated 3-D space such as a home room, attic, an office, streets and parking lots. While a truly omni-directional light may be difficult to produce with discrete LEDs, a well-mimicked omni-directional LED lamp can be constructed using a geodesic sphere with discrete LEDs covering as many of its surfaces as possible. A simpler version could be an octahedron or a dodecahedron solid with many or all of its 8 or 12 surfaces covered with discrete LEDs. Here the discrete LEDs can be in the chip or module forms or both.

This design concept can be extended to organic LEDs (OLEDs) where OLEDs may be used as discrete LEDs with larger chip sizes than conventional LEDs; multiple OLEDs may be used on multiple surfaces of a solid or of a 3-D object to generate multi-directional or omni-directional light. The advantage of OLEDs may be that they can be large area devices and a sphere could be constructed where the entire surface of the sphere can be evenly covered with OLEDs. Theoretically this would produce omni-directional light! Similarly the planar surfaces of any polyhedron such as an octahedron or a dodecahedron can be covered with broad area OLEDs to produce substantially omni-directional light.

According to the invention, the proposed LED lamp or luminaire design may provide the following:
a. Multi-directional light to illuminate broad space such as a room, office, attic, and others.
b. Substantially omni-directional light for general illumination.
c. Broad spatial lighting for street, parking lot and parking garage illumination.
d. Broad spatial lighting for outdoor patio, porch, and garden illumination.
e. Desired directional lighting with some but not all surfaces of a luminaire covered with discrete LEDs—for example, for a street light, the back of the lamp need not be populated with LEDs; however, the front and the sides may be populated to achieve broad area lighting below the luminaire.
f. Broad spatial lighting to illuminate a sign face that is two-dimensional.
g. Any other application that requires illumination over a broad area or 3-dimensional space such as display lighting, refrigerator case lighting, decorative lighting, etc.
h. Christmas or holiday lighting where it is desirable to have omni-directional light emitted from the lamps.
   The multi-directional and substantially omni-directional designs of this invention may produce LED lamps and luminaires for general lighting applications as well as such other applications as automotive headlights, projection lights, signage and display illumination, and many others. This invention could produce LED lamps and luminaires that may compete very well with incandescent, fluorescent and neon lights with respect to higher omni-directionality, more uniformity, and more purposefully-directed illumination.
   The proposed LED lamp design may use multiple LED chips or dies in linear and two-dimensional arrays on the same substrate; it may also use discrete packaged-LED modules in linear and two-dimensional arrays at the board level. The heat sinks can be placed under the boards and will be enclosed in the interior of the lamp with some openings in the overall 3-D lamp to remove the heat flow.
   This LED lamp and luminaire designs may be applied to produce single-color (e.g., red, blue, green, etc.) light sources or white light sources using either phosphor or red-green-blue color mixing technologies. This LED lamp design may employ LED chips fabricated using any well-established various inorganic material systems to produce different color LEDs as well as white LEDs. For example, to create a blue LED, the diode active layer may be InGaN or AlInGaN; similarly, to create a red LED, the diode active layer may be AlInGaP, GaAsP, or others. It may also use quantum-wells or double-heterostructure materials in the active region for better electrical or optical performance, or both.
   The disclosed LED lamp designs in this invention may also be use organic LEDs or OLEDs—meaning the invention of the basic design incorporating multiple LEDs on multiple surfaces of a solid or of a 3-D object to produce multi-directional or substantially omni-directional light for various illumination applications.

### BRIEF DESCRIPTION OF THE DRAWINGS

FIG. 1: The cross-sectional view of a typical LED chip on a sub-mount showing the dimensional differences. Although the figure is not drawn-to-scale with high accuracy, a single LED chip is usually more than ten times smaller than the sub-mount on which it is placed. The emitted light from this typical LED chip/die is very directional as shown in this figure with a grey cone.

FIG. 2: The cross-sectional view of a typical LED die/chip on a typical LED substrate/sub-mount ensemble. The schematic drawing is not-to-scale; in actual structures, the thickness of LED chip active layer is much smaller than even that shown when compared to the LED chip width and depth; similarly, the overall size of the LED chip/die is also much smaller compared to the substrate/sub-mount ensemble. The emitted light from this typical LED chip/die follows a very directional path as shown in this figure with a grey cone.

FIG. 3: Current practice primarily uses multiple LEDs on a single substrate as shown in this schematic to produce high-brightness LED luminaires. Here, 4 individual LED chips are used on a common substrate, which still produces substantially directional light output as shown by the grey cones.

FIG. 4: The schematic view of a proposed closely-mimicked omni-directional LED lamp that can plug into a base of a luminaire (shade not shown) to be powered electrically. The lamp is a rectangular-solid that has multiple LEDs on each of its 6 facets. Although each LED and each surface may produce directional light, the complete LED lamp or luminaire produces substantially omni-directional light.

FIG. 5: The proposed LED lamp of FIG. 4(a) without its front and back planes to show how each plane is populated with discrete LEDs.

FIG. 6: The proposed LED lamp's front plane where the height is longer than the back plane.

FIG. 7: The proposed LED lamp's back plane where the height is shorter than the front plane.

FIG. 8: The proposed LED lamp showing all 6 planes transparently to show the many LEDs on all facets simultaneously. The heat-sinks are within the enclosure of the 6 planes of the rectangular-solid LED lamp and therefore cannot be seen.

FIG. 9: The proposed LED lamp's top plane showing its heat-sink fins.

FIG. 10: Another example of a proposed LED lamp/luminaire design with a shape of an octahedron; the surfaces of this octahedron can be populated with discrete LEDs to achieve a multi-directional light output to effectively illuminate a room or an office. A few LEDs per surface are shown to exemplify along with the emanating light directions from some LEDs on some surfaces.

FIG. 11: Another example of a proposed LED lamp/luminaire design which has a shape of a dodecahedron; the surfaces of this dodecahedron can be populated with discrete LEDs to achieve a substantially omni-directional light output to effectively illuminate a room or an office. A few LEDs per surface are shown to exemplify along with the emanating light directions from some LEDs on some surfaces.

### DETAILED DESCRIPTION OF PREFERRED EMBODIMENTS

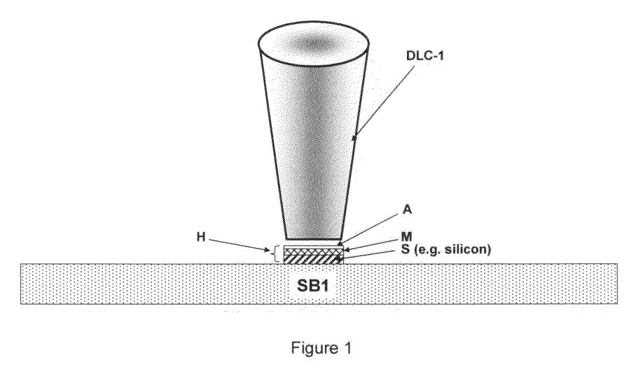

FIG. 1: The cross-sectional view of a typical LED chip on a sub-mount showing the dimensional differences. The figure is not drawn-to-scale with high accuracy because a single LED chip is usually more than ten times smaller than the sub-mount on which it is placed. [A typical LED chip size is 1 mm×1 mm (width×length) and the LED active layer thickness is around a micron, which is one-thousandth of a millimeter.] In FIG. 1, the emitted light from LED chip active layer A, is very directional as shown in this figure with a grey cone, DLC-1. The light can only come out active layer A vertically outward as shown with a grey cone here which is very directional. A is placed on a metal layer M, which is deposited on substrate S (for example, silicon). FIG. 1 also shows the overall thickness H of the LED chip ensemble containing A, M, and S. This ensemble is placed on a much bigger substrate board, SB1.

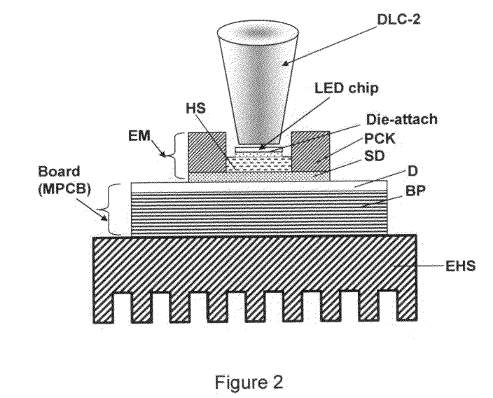

FIG. 2: The cross-sectional view of a typical LED die/chip on a typical LED substrate/sub-mount ensemble. The schematic drawing is not-to-scale. The emitted light from this typical LED chip/die ensemble follows a very directional path as shown in this figure with a grey directional light cone, DLC-2. In FIG. 2, the denoted “LED chip” is attached to the heat sink, HS, by denoted “Die-attach”. This “LED chip” on HS is secured in package PCK (the ensemble is also known as the emitter EM), which is then attached with solder SD to a dielectric board, D. Board D is attached to a base plate BP, which is then attached to an external heat sink, EHS. The ensemble of the dielectric D on base plate BP is called the “Board (MPCB) for multichip printed circuit board).

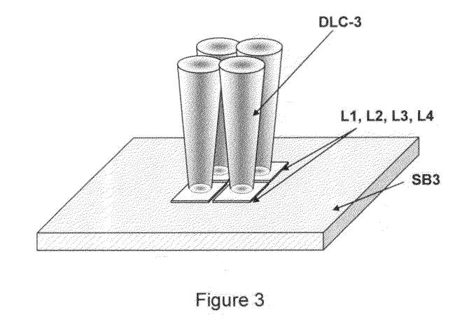

FIG. 3: Current practice primarily uses multiple LEDs on a single substrate as shown in this schematic to produce high-brightness LED luminaires. In FIG. 3, four individual LED emitters, L1, L2, L3 and L4 are used on a common substrate, SB3. which still produces substantially directional light output as shown by the grey cones, DLC-3.

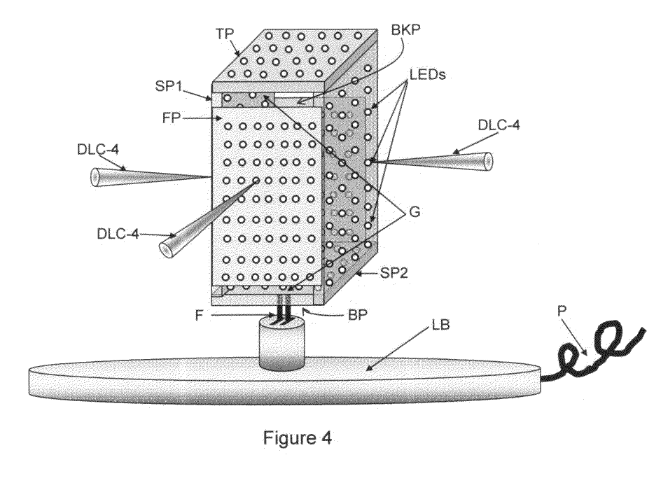

FIG. 4: A schematic view of a proposed closely-mimicked omni-directional LED lamp. In FIG. 4, the lamp is a rectangular-solid with 6 planes or facets that have multiple “LEDs” (shown in figure) on each of its 6 facets. This lamp is plugged into the base of a luminaire, LB, via an electrical feed, F. LB has an electrical power cord P. (The shade of the luminaire is not shown here.) In FIG. 4, the rectangular lamp has 6 planes: front plane, FP; back plane, BKP; top plane, TP; bottom plane, BP; left side plane, SP1; and right side plane, SP2. Although each LED and each surface may produce directional light, DLC-4, the complete LED lamp or luminaire produces substantially omni-directional light. In general, any 3-D shape may be used for a lamp with multiple LEDs covering the multiple facets (even non-planar surfaces) of the lamp. On front and back surfaces of this lamp, some air gap, G, is incorporated for heat escape.

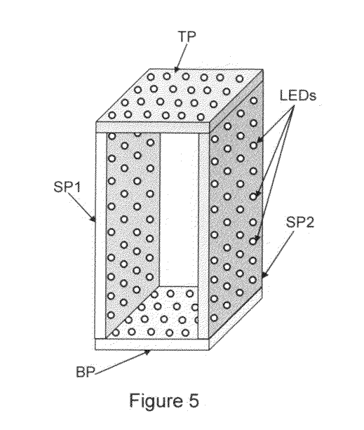

FIG. 5: The proposed LED lamp of FIG. 4 without its front and back planes. In FIG. 5, only top plane TP, bottom plane BP, left-side plane SP1, and right-side plane SP2 are depicted to clearly show how each plane is populated with discrete “LEDs” as denoted in FIG. 5.

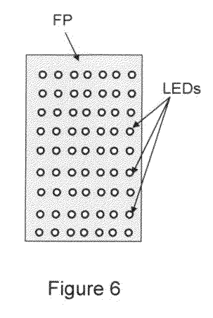

FIG. 6: FIG. 6 shows only the front plane of LED lamp in FIG. 4. In FIG. 6, only the front plane, FP, is shown, populated with “LEDs” as denoted in FIG. 6.

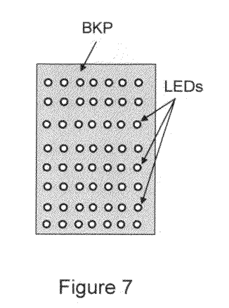

FIG. 7: FIG. 7 shows only the back plane of the proposed LED lamp in FIG. 4. In FIG. 7, only the back plane, BP, is shown, populated with “LEDs” as denoted in FIG. 7.

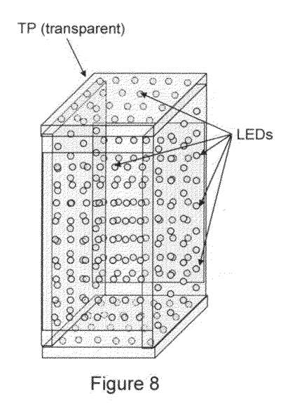

FIG. 8: The proposed LED lamp in FIG. 4, showing all 6 planes transparently to show the many “LEDs” (as denoted in FIG. 8) on all facets simultaneously. The heat-sinks are within the enclosure of the 6 planes of the rectangular-solid LED lamp and therefore cannot be seen in FIG. 8.

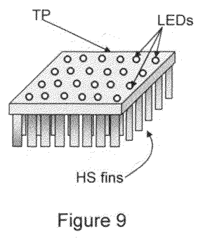

FIG. 9: The proposed LED lamp's top plane showing its heat-sink fins. In FIG. 9, top plane TP is shown, populated by “LEDs” (as denoted in this figure). At the bottom of TP, is a heat sink denoted by HS fins. The LED lamps bottom plane will have a similar heat sink also.

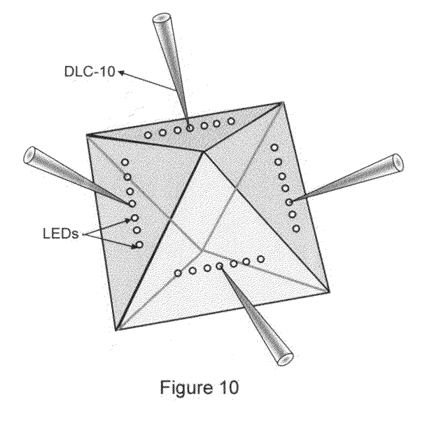

FIG. 10: Another example of a proposed LED lamp/luminaire design with a shape of an octahedron; In FIG. 10, the surfaces of this octahedron is populated with a few discrete “LEDs” as denoted in this figure, to achieve a multi-directional light output to effectively illuminate a room or an office. Only a few “LEDs” per surface are shown to exemplify along with the emanating light directions, DLC-10, from some LEDs on some surfaces. With more LEDs per surface, a higher degree of omni-directionality will be achieved in this type of LED lamp construction.

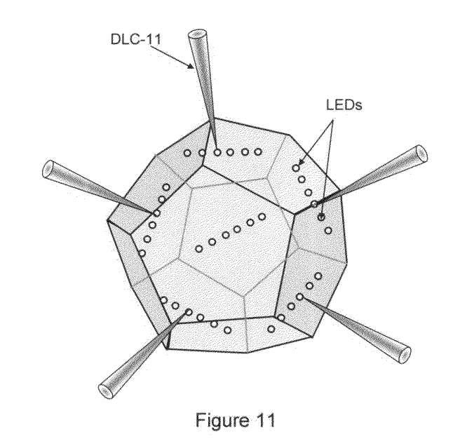

FIG. 11: Another example of a proposed LED lamp/luminaire design which has a shape of a dodecahedron. In FIG. 11, the surfaces of this dodecahedron is populated with a few discrete “LEDs” as denoted in this figure, to achieve a substantially omni-directional light output to effectively illuminate a room or an office. Only a few LEDs per surface are shown to exemplify along with the emanating light directions, DLC-11, from some LEDs on some surfaces. With more LEDs per surface, a higher degree of omni-directionality will be achieved in this type of LED lamp.

In this invention disclosure, I, M. Nisa Khan, claim the following:

1. An LED lamp and luminaire design comprising:
a. Multiple discrete LEDs on multiple facets of a solid or of a 3-D object to produce light in different directions.
b. Multiple discrete LED chips or LED modules on multiple facets to produce light in different directions and to increase omni-directionality of emitted light from the LED lamp and luminaire.
c. Multiple discrete LED chips or modules on multiple flat or curved facets to produce light in different directions and to increase omni-directionality of light emitted from the lamp or luminaire.
d. For thermal management, placing of heat sinks at the back of some or all of the surfaces comprising of boards that hold multiple LED modules or chips for the LED lamp or luminaire.
e. For thermal management, incorporating open holes or gaps in the LED lamp so that heat generated from operating the LED lamp can escape the luminaire. This is shown in FIG. 4(a).
f. Discrete LEDs may be both bare dies and packaged modules that are to be used to populate surfaces of the LED lamp.
g. The surfaces of the proposed 3-dimensional object LED lamp/luminaire may be flat or curved.
h. The surfaces of the proposed 3-dimensional solid or object LED lamp/luminaire may be in contact with other surfaces or there may be gaps between them, in which case it will not be a continuous one-piece solid.
i. It is believed that the proposed lamp/luminaire design will simultaneously produce multi-directional light and can produce substantially omni-directional light to effectively illuminate a desired space.

2. The proposed LED lamp design concept can be applied to produce light only where one needs it. For example an LED lamp or luminaire that needs to be placed flushed with a ceiling—should be shaped like a hemisphere and not like a sphere, rectangular solid, octahedron, or a dodecahedron; the light from a hemispherical lamp will illuminate the space below it fairly uniformly, but not above it.

3. The proposed LED lamp design concept can be applied to produce light only where one needs it. For example an LED lamp or luminaire that needs to be placed in the corner of a room—should be shaped like a cone or half a cone, but not like a sphere, rectangular solid, octahedron, or a dodecahedron; the light from a conical or semi-conical lamp will illuminate the room fairly uniformly from a corner.

4. The lamp design can be employed to produce various color light sources by using different LED chips in both organic and inorganic semiconductors. Depending on what color LED is desired, the active layer can be any inorganic semiconductor such as InGaN, AlInGaN, AlInGaP, GaAsP, or any other material system that has been or will be used to produce LEDs of various color in the industry.

5. The proposed lamp designs can be used to make white LED lamps; the LED chips in this case may be produced using blue or green LEDs in conjunction with suitable phosphors. Alternatively, mixed-color (red, green, blue, or other) LEDs may be used to produce white LED chips or modules for the lamp.

6. The LED lamp designs proposed in this invention may also used for organic LEDs or OLEDs to populate surfaces of the lamp.

7. The proposed lamp designs are at the lamp/luminaire level and can in principle use any light sources as long as they can be small enough to be placed in a discrete fashion on various surfaces to create a 3-dimensional lamp such as those in FIGS. 4, 5, and 6.

8. This invention's LED lamp and luminaire designs may be used for general lighting applications as well as such other applications as automotive headlights, projection lights, signage and display illumination, and many others.
